(19) United States
(12) Patent Application Publication
(10) Pub. No.: US 2025/0210634 A1
(43) Pub. Date: Jun. 26, 2025

(54) COMPOSITE POSITIVE ELECTRODE ACTIVE MATERIAL

(71) Applicant: TOYOTA JIDOSHA KABUSHIKI KAISHA, Toyota-shi (JP)

(72) Inventors: Heidyhodex VISBALMENDOZA, Toyota-shi (JP); Nobuki Kyono, Obu-shi (JP)

(73) Assignee: TOYOTA JIDOSHA KABUSHIKI KAISHA, Toyota-shi (JP)

(21) Appl. No.: 18/968,168

(22) Filed: Dec. 4, 2024

(30) Foreign Application Priority Data
Dec. 20, 2023 (JP) 2023-214420

(51) Int. Cl. H01M 4/36; H01M 4/02; H01M 4/525; H01M 10/0562

(52) U.S. Cl. CPC H01M 4/366; H01M 4/525; H01M 10/0562; H01M 2004/028; H01M 2300/0068

(57) ABSTRACT

A composite positive electrode active material including a positive electrode active material and a lithium-ion conducting oxide containing at least one element of elemental B and elemental P on at least a part of the surface of the positive electrode active material, wherein the composite positive electrode active material contains a solid electrolyte on at least a part of the surface of the lithium-ion conducting oxide, and wherein the interface length value A (μm⁻¹) obtained by dividing the length (μm) of the interface between the positive electrode active material and the solid electrolyte confirmed from an SEM image of a cross section of the composite positive electrode active material by the area (μm²) of the positive electrode active material in the SEM image is 1.326 or more.

### CROSS-REFERENCE TO RELATED APPLICATION

This application claims priority to Japanese Patent Application No. 2023-214420 filed on Dec. 20, 2023, incorporated herein by reference in its entirety.

### BACKGROUND

### 1. Technical Field

The present disclosure relates to a composite positive electrode active material.

### 2. Description of Related Art

Various techniques regarding composite positive electrode active materials such as those disclosed in Japanese Unexamined Patent Application Publication No. 2021-163580 (JP 2021-163580 A) have been proposed.

### SUMMARY

In the related art, in a cross-sectional image of composite positive electrode active material particles, the area percentage of the solid electrolyte at a predetermined distance from the surface of the positive electrode active material particles is 40% or more. However, even if the area percentage is high, when the length of the contact interface between the positive electrode active material and the solid electrolyte in the electrode is short, the resistance of the battery is high.

The present disclosure has been made in view of the above circumstances, and a main object of the present disclosure is to provide a composite positive electrode active material that can reduce the resistance of a battery.

Specifically, the present disclosure includes the following aspects.

<1> A composite positive electrode active material, including
a positive electrode active material and a lithium-ion conducting oxide containing at least one element of elemental B and elemental P on at least a part of the surface of the positive electrode active material,
wherein the composite positive electrode active material contains a solid electrolyte on at least a part of the surface of the lithium-ion conducting oxide, and
wherein the interface length value A (μm⁻¹) obtained by dividing the length (μm) of the interface between the positive electrode active material and the solid electrolyte confirmed from an SEM image of a cross section of the composite positive electrode active material by the area (μm²) of the positive electrode active material in the SEM image is 1.326 or more.

<2> The composite positive electrode active material according to <1>,
wherein the positive electrode active material is positive electrode active material particles, and
wherein the average particle size of the positive electrode active material particles is 3 μm or more and 4.5 μm or less.

<3> The composite positive electrode active material according to <1> or <2>,
wherein the solid electrolyte is a sulfide-based solid electrolyte.

<4> A positive electrode including a positive electrode layer containing the composite positive electrode active material according to any one of <1> to <3>, and a positive electrode current collector.

<5> A method of producing a composite positive electrode active material, including:
a first process in which at least a part of the surface of a positive electrode active material is coated with a lithium-ion conducting oxide containing at least one element of elemental B and elemental P; and
a second process in which at least a part of the surface of the lithium-ion conducting oxide is coated with a solid electrolyte,
wherein the interface length value A (μm⁻¹) obtained by dividing the length (μm) of the interface between the positive electrode active material and the solid electrolyte confirmed from an SEM image of a cross section of the composite positive electrode active material by the area (μm²) of the positive electrode active material in the SEM image is 1.326 or more.

The composite positive electrode active material of the present disclosure can reduce the resistance of a battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a graph showing the relationship between an interface length value A and a battery resistance.

### DETAILED DESCRIPTION OF EMBODIMENTS

Embodiments of the present disclosure will be described below. Here, components other than those particularly mentioned in this specification that are necessary for implementation of the present disclosure (for example, a general configuration and a production process of a composite positive electrode active material that do not characterize the present disclosure) can be recognized by those skilled in the art as design matters based on the related art in the field. The present disclosure can be implemented based on content disclosed in this specification and common general technical knowledge in the field.

In the present disclosure, when a battery is a fully charged, this means that the state of charge (SOC) of the battery is 100%. The SOC indicates a ratio of the charge capacity to the fully charged capacity of the battery, and the fully charged capacity is SOC 100%.

The SOC may be estimated from, for example, an open circuit voltage (OCV) of the battery.

In the present disclosure, there is provided a composite positive electrode active material including a positive electrode active material and a lithium-ion conducting oxide containing at least one element of elemental B and elemental P on at least a part of the surface of the positive electrode active material,
wherein the composite positive electrode active material contains a solid electrolyte on at least a part of the surface of the lithium-ion conducting oxide, and
wherein the interface length value A (μm⁻¹) obtained by dividing the length (μm) of the interface between the positive electrode active material and the solid electrolyte confirmed from an SEM image of a cross section of the composite positive electrode active material by the area (μm²) of the positive electrode active material in the SEM image is 1.326 or more.

The interface length value A (μm⁻¹) obtained by dividing the length (μm) of the interface between the positive electrode active material and the solid electrolyte confirmed from a scanning electron microscope (SEM) image of a cross section of the composite positive electrode active material of the present disclosure by the area (μm²) of the positive electrode active material in the SEM image may be 1.326 or more, and the interface length value A may be 1.326 μm⁻¹ or more and 1.632 μm⁻¹ or less.

The interface length value A may be controlled by at least one method selected from the group consisting of changing the volume proportion of the solid electrolyte in the composite positive electrode active material, changing the coverage of the solid electrolyte covering the lithium-ion conducting oxide, and changing the solid electrolyte coating method.

In the present disclosure, when the interface length value A is 1.326 or more, the resistance of the battery can be reduced.

Examples of positive electrode active materials include oxide active materials. Examples of oxide active materials include LiNi_{0.8}Co_{0.15}Al_{0.05}O₂, LiCoO₂, LiMnO₂, LiNiO₂, LiVO₂, LiNi_{1/3}Co_{1/3}Mn_{1/3}O₂, LiMn₂O₄, Li(Ni_{0.5}Mn_{1.5})O₄, LiFePO₄, LiMnPO₄, LiNiPO₄, and LiCuPO₄.

The positive electrode active material may be positive electrode active material particles.

The average particle size of the positive electrode active material particles may be 3 μm or more and 4.5 μm or less.

In the present disclosure, unless otherwise specified, the average particle size of particles is a median diameter (D50) value, which is a particle size at a cumulative value of 50% in the volume-based particle size distribution measured by laser diffraction/scattering particle size distribution measurement.

The composite positive electrode active material of the present disclosure may contain a lithium-ion conducting oxide containing elemental B and elemental P on at least a part of the surface of the positive electrode active material and may contain a lithium-ion conducting oxide containing elemental B and elemental P on the entire surface of the positive electrode active material.

The lithium-ion conducting oxide may contain at least one element of elemental B and elemental P. Examples of lithium-ion conducting oxides include B₂O₃, Li₂B₄O₇, LiBPO₄, Li₃PO₄, and LiPO₃. The thickness of the lithium-ion conducting oxide is, for example, 0.1 nm or more, and may be 1 nm or more. On the other hand, the thickness of the lithium-ion conducting oxide is, for example, 100 nm or less, and may be 20 nm or less. The coverage of the lithium-ion conducting oxide covering the positive electrode active material is not particularly limited as long as having the interface length value A defined in the present disclosure can be satisfied. The coverage of the lithium-ion conducting oxide covering the positive electrode active material is, for example, 70% or more, and may be 90% or more.

The composite positive electrode active material of the present disclosure may contain a solid electrolyte on at least a part of the surface of the lithium-ion conducting oxide, and may contain a solid electrolyte on the entire surface of the lithium-ion conducting oxide.

The coverage of the solid electrolyte covering the lithium-ion conducting oxide is not particularly limited as long as having the interface length value A defined in the present disclosure can be satisfied. The coverage of the solid electrolyte covering the lithium-ion conducting oxide is, for example, 70% or more, and may be 90% or more.

Examples of solid electrolytes include sulfide-based solid electrolytes and oxide-based solid electrolytes.

Examples of sulfide-based solid electrolytes include solid electrolytes containing elemental Li, elements M (M is at least one of P, As, Sb, Si, Ge, Sn, B, Al, Ga, and In), and elemental S. In addition, the sulfide-based solid electrolyte may further contain at least one of elemental O and a halogen element.

Examples of sulfide-based solid electrolytes include Li₂S—P₂S₅, Li₂S—SiS₂, LiX—Li₂S—SiS₂, LiX—Li₂S—P₂S₅, LiX—Li₂O—Li₂S—P₂S₅, LiX—Li₂S—P₂O₅, LiX—Li₃PO₄—P₂S₅, and Li₃PS₄. Here, the above reference to “Li₂S—P₂S₅” means a material obtained using a raw material composition containing Li₂S and P₂S₅, and the same applies to other description.

In addition, “X” in the LiX indicates a halogen element. Examples of halogen elements include elemental F, elemental Cl, elemental Br, and elemental I. The LiX-containing raw material composition may contain one, two or more types of LiX. When two or more types of LiX are contained, the mixing ratio of two or more types is not particularly limited.

The molar ratio of the elements in the sulfide-based solid electrolyte can be controlled by adjusting the content of each element in the raw material. In addition, the molar ratio and compositions of the elements in the sulfide-based solid electrolyte can be measured through, for example, ICP emission spectroscopy.

The sulfide-based solid electrolyte may be sulfide glass or crystallized sulfide glass (glass ceramics) or may be a crystalline material obtained by performing a solid-phase reaction treatment on the raw material composition.

The crystalline state of the sulfide-based solid electrolyte can be confirmed, for example, by performing powder X-ray diffraction measurement using CuKα rays for the sulfide-based solid electrolyte.

Sulfide glass can be obtained by performing amorphous processing on the raw material composition (for example, a mixture of Li₂S and P₂S₅). Examples of amorphous processing include mechanical milling.

Glass ceramics can be obtained by heating, for example, sulfide glass.

The heat treatment temperature may be a temperature higher than the crystallization temperature (Tc) of sulfide glass observed by thermal analysis measurement, and is generally 195° C. or higher. On the other hand, the upper limit of the heat treatment temperature is not particularly limited.

The crystallization temperature (Tc) of sulfide glass can be measured by differential thermal analysis (DTA).

The heat treatment time is not particularly limited as long as it is a time during which a desired degree of crystallization of glass ceramics is obtained, and is, for example, in a range of 1 minute to 24 hours, and particularly in a range of 1 minute to 10 hours.

The heat treatment method is not particularly limited, and for example, a method using a baking furnace can be used.

Examples of oxide-based solid electrolytes include substances having a garnet-type crystal structure containing elemental Li, elemental La, elements A (A is at least one of Zr, Nb, Ta, and Al), and elemental O. Examples of oxide-based solid electrolytes include Li₂O—B₂O₃—P₂O₅, Li₂O—SiO₂, Li₂O—B₂O₃, Li_{1.3}Al_{0.3}Ti_{0.7}(PO₄)₃, Li₅La₃Ta₂O₁₂, Li₇La₃Zr₂O₁₂, Li₆BaLa₂Ta₂O₁₂, Li_{3.6}Si_{0.6}P_{0.4}O₄, Li₄SiO₄, Li₃PO₄, and Li₃₊ₓPO₄₋ₓNₓ (1≤x≤3).

The shape of the solid electrolyte may be a particle shape in consideration of ease of handling.

In addition, the average particle size (D50) of the solid electrolyte particle is not particularly limited, and the lower limit may be 0.5 μm or more, and the upper limit may be 2 μm or less.

In the present disclosure, there is provided a method of producing a composite positive electrode active material includes a first process in which at least a part of the surface of a positive electrode active material is coated with a lithium-ion conducting oxide containing at least one element of elemental B and elemental P, and a second process in which at least a part of the surface of the lithium-ion conducting oxide is coated with a solid electrolyte, wherein the interface length value A (μm⁻¹) obtained by dividing the length (μm) of the interface between the positive electrode active material and the solid electrolyte confirmed from an SEM image of a cross section of the composite positive electrode active material by the area (μm²) of the positive electrode active material in the SEM image is 1.326 or more.

In the present disclosure, in the first process, at least a part of the surface of the positive electrode active material is coated with a lithium-ion conducting oxide, and in the second process, at least a part of the surface is additionally coated with a solid electrolyte. The coating method in the first process and the second process is not particularly limited, and a conventionally known method can be appropriately used.

The composite positive electrode active material of the present disclosure is generally used to produce a positive electrode of a battery.

A method of producing a positive electrode of the present disclosure includes a process of applying a positive electrode slurry to at least one surface of a positive electrode current collector and drying it.

The positive electrode slurry may contain a composite positive electrode active material, a conductive material, a binder, a thickener, a solvent and the like.

The method of applying a positive electrode slurry is not particularly limited, and a conventionally known method can be used.

Examples of materials of positive electrode current collectors include metals such as aluminum, copper, SUS, and nickel. The thickness of the positive electrode current collector is, for example, 0.1 μm or more and 100 μm or less. The shape of the positive electrode current collector may be a sheet shape or the like.

Examples of binders include acrylonitrile butadiene rubber (ABR), polyvinylidene fluoride (PVDF), polytetrafluoroethylene (PTFE), and styrene-butadiene rubber (SBR).

Examples of conductive materials include carbon materials, metal particles, and conductive polymers. Examples of carbon materials include particulate carbon materials such as acetylene black (AB) and Ketjen black (KB); and fibrous carbon materials such as carbon fibers, carbon nanotubes (CNT) and carbon nanofibers (CNF).

Examples of thickeners include polysaccharides such as carboxymethylcellulose (CMC) and methylcellulose.

Examples of solvents include aqueous solvents and organic solvents. The aqueous solvent refers to water or a mixed solvent containing water and a polar organic solvent. For example, an appropriate solvent can be selected depending on the types of the positive electrode active material, the binder and the like.

As the aqueous solvent, water is preferably used because of its ease of handling. Examples of polar organic solvents that can be used in the mixed solvent include alcohols such as methanol, ethanol, and isopropyl alcohol, ketones such as acetone, and ethers such as tetrahydrofuran.

Examples of organic solvents include 1,2,3,4-tetrahydronaphthalene, n-heptane, butyl butyrate, diisobutyl ketone, and N-methyl-2-pyrrolidone (NMP).

The positive electrode of the present disclosure includes a positive electrode current collector and a positive electrode layer formed by drying a positive electrode slurry applied to at least one surface of the positive electrode current collector.

The positive electrode layer contains the composite positive electrode active material, and as necessary, may contain the solid electrolyte, the binder, the conductive material and the like.

The content proportion of the composite positive electrode active material in the positive electrode layer is not particularly limited, and may be 50.0 to 81.2 mass %.

The content proportion of the solid electrolyte in the positive electrode layer is not particularly limited, and may be 0 to 16.5 mass %.

The interface length value A of the present disclosure may be a value obtained by dividing the length (μm) of the interface between the positive electrode active material and the solid electrolyte confirmed from an SEM image of a cross section of the positive electrode layer by the area (μm²) of the positive electrode active material in the SEM image.

The positive electrode of the present disclosure is generally used in the production of a battery.

The battery includes a positive electrode, an electrolyte layer, and a negative electrode.

The electrolyte layer may be a liquid electrolyte layer using an electrolytic solution as an electrolyte or may be a solid electrolyte layer using a solid electrolyte as an electrolyte.

As the electrolytic solution, a conventionally known electrolytic solution used in a lithium-ion secondary battery can be used.

The solid electrolyte layer contains at least a solid electrolyte.

As the solid electrolyte contained in the solid electrolyte layer, a known solid electrolyte that can be used in a solid battery can be appropriately used, and examples thereof included the oxide-based solid electrolyte and sulfide-based solid electrolyte described above. In order to prevent the positive electrode layer and the negative electrode layer from peeling off from the solid electrolyte layer, a relatively soft sulfide-based solid electrolyte may be used as the solid electrolyte.

The solid electrolytes may be used alone or two or more thereof may be used in combination. In addition, when two or more types of solid electrolytes are used, the two or more types of solid electrolytes may be mixed, or two or more layers of the solid electrolyte may be formed to form a multi-layer structure.

The proportion of the solid electrolyte in the solid electrolyte layer is not particularly limited, and is, for example, 50 mass % or more, and may be in a range of 60 mass % or more and 100 mass % or less, in a range of 70 mass % or more and 100 mass % or less, and may be 100 mass %.

The solid electrolyte layer may contain a binder in order to exhibit plasticity. Examples of such binders include materials exemplified as binders used in the positive electrode layer described above. However, in order to easily achieve a high output, the content of the binder contained in the solid electrolyte layer may be 5 mass % or less in order to prevent excessive aggregation of the solid electrolyte and enable the formation of a solid electrolyte layer containing a uniformly dispersed solid electrolyte.

The thickness of the solid electrolyte layer is not particularly limited, and is generally 0.1 μm or more and 1 mm or less.

The negative electrode includes a negative electrode layer and a negative electrode current collector.

The negative electrode layer contains a negative electrode active material, and as necessary, contains a conductive material, a binder and the like.

Examples of negative electrode active materials include carbon active materials, oxide active materials and metal active materials. Examples of carbon active materials include mesocarbon microbeads (MCMB), highly oriented pyrolytic graphite (HOPG), hard carbon and soft carbon. Examples of oxide active materials include Nb₂O₅, Li₄Ti₅O₁₂ and SiO. Examples of metal active materials include In, Al, Si and Sn.

Examples of conductive materials and binders include materials exemplified as the conductive material and binder used in the positive electrode layer described above.

The material of the negative electrode current collector may be a material that is not alloyed with Li, and examples thereof include SUS, copper and nickel. Examples of the form of the negative electrode current collector include a foil form and a plate form. The shape of the negative electrode current collector in a plan view is not particularly limited, and examples thereof include a circular shape, an elliptical shape, a rectangular shape and any polygonal shape. In addition, the thickness of the negative electrode current collector varies depending on the shape, and may be, for example, in a range of 1 μm to 50 μm or in a range of 5 μm to 20 μm.

The type of the battery is not particularly limited, and may be, for example, a lithium-ion secondary battery. The battery may be a liquid battery using an electrolytic solution as an electrolyte or a solid battery using a solid electrolyte as an electrolyte. Applications of batteries include power sources for vehicles, for example, hybrid electric vehicles (HEV), plug-in hybrid electric vehicles (PHEV), battery electric vehicles (BEV), gasoline vehicles, and diesel vehicles. Among these, the battery may be used as a power source for driving hybrid electric vehicles (HEV), plug-in hybrid electric vehicles (PHEV) or battery electric vehicles (BEV). In addition, the battery may be used as a power source for moving objects (for example, trains, ships, and aircrafts) other than vehicles, and may be used as a power source for electrical products such as information processing devices.

### Examples 1 to 3 and Comparative Examples 1 to 3

### [Preparation of Composite Positive Electrode Active Material]

LiNi_{0.8}Co_{0.15}Al_{0.05}O₂ particles were used as the positive electrode active material. Particles of a compound containing at least one element of elemental B and elemental P were used as the lithium-ion conducting oxide. Sulfide glass solid electrolyte particles were used as the solid electrolyte. The surface of positive electrode active material particles was coated with lithium-ion conducting oxide particles. The positive electrode active material particles coated with the lithium-ion conducting oxide particles and the solid electrolyte particles were stirred and mixed to obtain composite positive electrode active material particles in which the surface of the lithium-ion conducting oxide particles was coated with the solid electrolyte particles.

### [Preparation of Positive Electrode]

As the solvent, 1,2,3,4-tetrahydronaphthalene was used. As the positive electrode active material, the composite positive electrode active material particles obtained above were used. As the solid electrolyte, sulfide glass solid electrolyte particles were used. As the binder, SBR was used. As the conductive material, carbon nanotubes were used. The composite positive electrode active material particles, the solid electrolyte particles, the binder and the conductive material were mixed in the solvent at the following mass composition ratio to prepare a positive electrode slurry.

Mass composition ratio composite positive electrode active material:solid electrolyte:binder:conductive material=81.2:16.5:0.3:1.9

The prepared positive electrode slurry was applied onto a positive electrode current collector. Then, the applied positive electrode slurry was dried. Thereby, a positive electrode having a positive electrode layer on the positive electrode current collector was obtained.

### [Preparation of Solid Electrolyte Layer]

As the solvent, n-heptane and butyl butyrate were used. As the solid electrolyte, a sulfide glass solid electrolyte was used. As the binder, acrylonitrile butadiene rubber (ABR) was used. The solid electrolyte and the binder were mixed in a solvent to prepare a solid electrolyte slurry.

The prepared solid electrolyte slurry was applied onto a release film. Then, the applied solid electrolyte slurry was dried. The release film was peeled off from the dried solid electrolyte coated foil to obtain a solid electrolyte layer.

### [Preparation of Negative Electrode]

As the solvent, diisobutyl ketone was used. As the negative electrode active material, Li₄Ti₅O₁₂ was used. As the solid electrolyte, a sulfide glass solid electrolyte was used. As the binder, SBR was used. As the conductive material, carbon nanotubes were used. The negative electrode active material, the solid electrolyte, the binder and the conductive material were mixed in the solvent at the following mass composition ratio to prepare a negative electrode slurry.

Mass composition ratio negative electrode active material:solid electrolyte:binder:conductive material=72.2:24.3:1.8:2.4

The prepared negative electrode slurry was applied onto a negative electrode current collector. Then, the applied negative electrode slurry was dried. Thereby, a negative electrode having a negative electrode layer on the negative electrode current collector was obtained.

### [Preparation of Cell]

The prepared positive electrode, the prepared solid electrolyte layer, and the prepared negative electrode were disposed in that order to obtain a laminate. A positive electrode tab was attached to the positive electrode, and a negative electrode tab was attached to the negative electrode. Then, the laminate was accommodated in a laminate film, the inside of the laminate film was vacuumed to seal the laminate and a laminate cell (sometimes referred to as a cell) was prepared. The cell restraining pressure was 5 MPa with respect to the electrode area.

### [Method of Calculating Length of Interface Between Positive Electrode Active Material and Solid Electrolyte in Positive Electrode Layer]

First, a binary image of the positive electrode active material and the solid electrolyte was created from a cross-sectional SEM image of the positive electrode layer. The binary image was created using image analysis software. In this case, “ImageJ” was used.

Next, the area of the positive electrode active material in the image and the length of the contact interface between the positive electrode active material and the solid electrolyte were calculated using image analysis software. In this case, “MATLAB (registered trademark)” was used for calculation. Using these values, the normalized interface length value A was calculated by the following formula. The results are shown in Table 1. Interface length value A[μm⁻¹]=(length [μm] of the contact interface between the positive electrode active material and the solid electrolyte in the analysis image)/(area [μm²] of the positive electrode active material in the analysis image)

The cells of Examples 1 to 3 and Comparative Examples 1 to 3 had the same configuration except that the interface length value A between the positive electrode active material and the solid electrolyte in the positive electrode layer was the value shown in Table 1.

The interface length value A was controlled by at least one method selected from the group consisting of changing the volume proportion of the solid electrolyte in the composite positive electrode active material contained in the positive electrode layer, changing the coverage of the solid electrolyte covering the lithium-ion conducting oxide, and changing the solid electrolyte coating method.

A positive electrode layer having a larger interface length value A has a larger area in which the positive electrode active material can undergo a lithium ion insertion/desorption reaction than a positive electrode layer having a smaller interface length value A, which leads to a reduction in battery resistance.

### [Evaluation of Charging and Discharging]

The prepared laminate cell was subjected to charging and discharging evaluation. The test performed was as follows. Activation, capacity measurement, and battery resistance measurement were performed at 25° C.
Activation: CCCV charging 0.333C-0.01C cut upper limit 2.80 V→CCCV discharging 0.333C-0.01C cut lower limit 1.5 V
Capacity measurement: the program was the same as for activation.
Battery resistance measurement: the voltage change ΔV value when a current with a value of 2.5C rate flowed at 20% SOC (discharge resistance) was read and the resistance value was calculated by Ohm's law V=IR.
   Durability test: a cycle test was performed in a cycle voltage range of 1.45 to 2.80 V, 60° C., and 1C rate. After the durability test, again, the capacity was measured, and the battery resistance after the durability test was then measured. Table 1 shows the battery resistance after the durability test.

TABLE 1

| | Interface length | Battery |
|---|---|---|
| | value A [μm⁻¹] | resistance [Ω] |
| Comparative Example 1 | 1.251 | 30.0 |
| Comparative Example 2 | 1.187 | 32.8 |
| Comparative Example 3 | 1.217 | 33.2 |
| Example 1 | 1.326 | 24.7 |
| Example 2 | 1.356 | 22.9 |
| Example 3 | 1.632 | 19.5 |

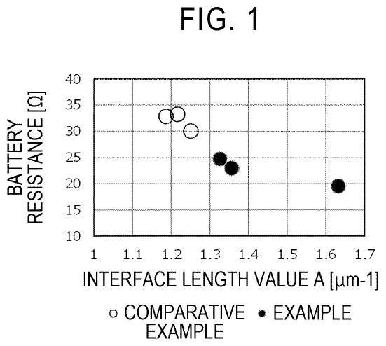

FIG. 1 is a graph showing the relationship between the interface length value A and the battery resistance.

As shown in FIG. 1 and Table 1, in the present disclosure, when the interface length value A was 1.326 or more, the resistance of the battery could be reduced.

What is claimed is:

1. A composite positive electrode active material comprising
a positive electrode active material and a lithium-ion conducting oxide containing at least one element of elemental B and elemental P on at least a part of the surface of the positive electrode active material,
wherein the composite positive electrode active material contains a solid electrolyte on at least a part of the surface of the lithium-ion conducting oxide, and
wherein the interface length value A (μm⁻¹) obtained by dividing the length (μm) of the interface between the positive electrode active material and the solid electrolyte confirmed from an SEM image of a cross section of the composite positive electrode active material by the area (μm²) of the positive electrode active material in the SEM image is 1.326 or more.

2. The composite positive electrode active material according to claim 1,
wherein the positive electrode active material is positive electrode active material particles, and
wherein the average particle size of the positive electrode active material particles is 3 μm or more and 4.5 μm or less.

3. The composite positive electrode active material according to claim 1,
wherein the solid electrolyte is a sulfide-based solid electrolyte.

4. A positive electrode comprising a positive electrode layer containing the composite positive electrode active material according to claim 1, and a positive electrode current collector.

5. A method of producing a composite positive electrode active material, comprising:
a first process in which at least a part of the surface of a positive electrode active material is coated with a lithium-ion conducting oxide containing at least one element of elemental B and elemental P; and
a second process in which at least a part of the surface of the lithium-ion conducting oxide is coated with a solid electrolyte,
wherein the interface length value A (μm⁻¹) obtained by dividing the length (μm) of the interface between the positive electrode active material and the solid electrolyte confirmed from an SEM image of a cross section of the composite positive electrode active material by the area (μm²) of the positive electrode active material in the SEM image is 1.326 or more.
